(19) United States
(12) Patent Application Publication
(10) Pub. No.: US 2013/0162699 A1
(43) Pub. Date: Jun. 27, 2013

(54) ACTIVE MATRIX TYPE BISTABLE CHIRAL NEMATIC LIQUID CRYSTAL DISPLAY AND DRIVING METHOD THEREOF

(71) Applicant: Industrial Technology Research Institute, Chutung (TW)

(72) Inventors: Chih-Jen CHEN, Tainan City (TW); Chien-Chih HSU, Tongxiao Township (TW); Chih-Hung WU, New Taipei City (TW)

(73) Assignee: INDUSTRIAL TECHNOLOGY RESEARCH INSTITUTE, Chutung (TW)

(21) Appl. No.: 13/722,542

(22) Filed: Dec. 20, 2012

(30) Foreign Application Priority Data
Dec. 23, 2011 (TW) 100148221

(51) Int. Cl. G09G 3/36

(52) U.S. Cl. CPC G09G 3/3651
USPC 345/690; 345/89

(57) ABSTRACT

The disclosure provides a driving method for an active matrix type bistable chiral nematic liquid crystal display, including: dividing a frame into at least two fields, wherein each field is formed by a plurality of pixel rows; driving one of the at least two fields by a plurality of driving operations, wherein a liquid crystal unit of each pixel in the field is driven to one of two predetermined states in each driving operation; and driving the other fields by the plurality of driving operations.

### CROSS REFERENCE TO RELATED APPLICATIONS

This Application claims priority of Taiwan Patent Application No. 100148221, filed on Dec. 23, 2011, the entirety of which is incorporated by reference herein.

### BACKGROUND

1. Technical Field

The present disclosure relates to an active matrix type bistable chiral nematic liquid crystal display and the driving method thereof, and in particular relates to an active matrix type bistable chiral nematic liquid crystal display and the driving method thereof capable of increasing frame rate.

2. Description of the Related Art

Of the many types of liquid crystals, cholesteric liquid crystals are a bistable chiral nematic liquid crystal. A common liquid crystal display needs to hold a voltage to maintain the arrangement of liquid crystal molecules. Relatively, an active matrix type bistable chiral nematic liquid crystal display has bistable characteristics, which are low power consumption, low cost, high contrast ration, and wide view angle. Furthermore, the active matrix type bistable chiral nematic liquid crystal display has higher contrast ratio and lower power consumption than a passive matrix type bistable chiral nematic liquid crystal displays and solves the cross talk issue inherent with the passive type structure to display with better image quality. However, bistable chiral nematic liquid crystals have low response speed. If a driving method for a common active type liquid crystal display is adapted to the active matrix type bistable chiral nematic liquid crystal display, insufficient contrast ratio or flicker may occur. Moreover, if the active matrix type bistable chiral nematic liquid crystal display is driven by several sub-frames to display gray level, a low frame rate will be an issue to be solved.

### SUMMARY

The disclosure provides a driving method for an active matrix type bistable chiral nematic liquid crystal display, including: dividing a frame into at least two fields, wherein each field is formed by a plurality of pixel rows; driving one of the at least two fields by a plurality of driving operations, wherein a liquid crystal unit of each pixel in the field is driven to one of two predetermined states in each driving operation; and driving the other fields by the plurality of driving operations.

The disclosure also provides an active matrix type bistable chiral nematic liquid crystal display, including: a pixel array formed by a plurality of pixel rows and pixel columns, wherein the active matrix type bistable chiral nematic liquid crystal display is driven with the driving method for the active matrix type bistable chiral nematic liquid crystal display as described above.

A detailed description is given in the following embodiments with reference to the accompanying drawings.

### BRIEF DESCRIPTION OF DRAWINGS

The present disclosure can be more fully understood by reading the subsequent detailed description and examples with references made to the accompanying drawings, wherein:

FIG. 1 shows a pixel structure of an active matrix type bistable chiral nematic liquid crystal display in accordance with an embodiment of the disclosure.

FIG. 2 is a diagram showing a conventional driving method of an active matrix type bistable chiral nematic liquid crystal display.

FIG. 3 is a diagram showing a driving method of an active matrix type bistable chiral nematic liquid crystal display in accordance with an embodiment of the present disclosure.

FIG. 4 is a diagram showing the displayable gray levels of an active matrix type bistable chiral nematic liquid crystal display when the driving method shown in FIG. 3 is utilized.

FIG. 5 is a diagram showing the displayable gray levels of an active matrix type bistable chiral nematic liquid crystal display in accordance with another embodiment of the present disclosure.

FIG. 6 is a diagram showing a driving method of an active matrix type bistable chiral nematic liquid crystal display in accordance with another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

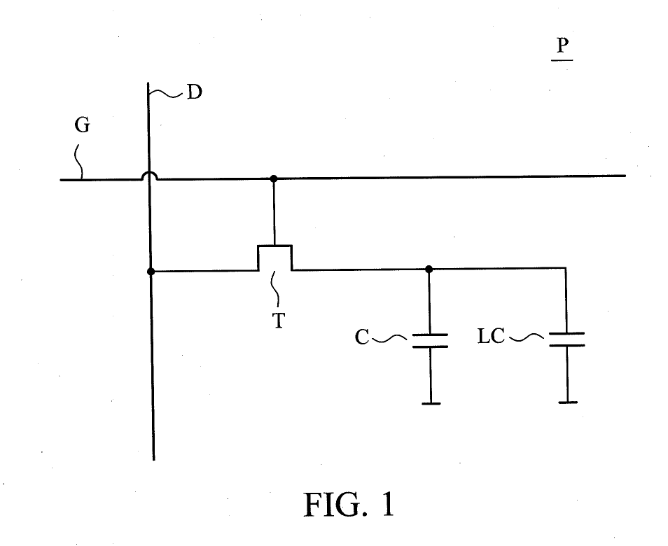

FIG. 1 shows a pixel structure of an active matrix type bistable chiral nematic liquid crystal display in accordance with an embodiment of the disclosure. As shown in FIG. 1, each pixel P includes a transistor T, a capacitor C, and a liquid crystal layer LC. When the scan line G transmits a scan signal to select the pixel P, the transistor T is conducted so that a data signal on the data line D is written into the pixel P to drive the liquid crystal layer LC. The capacitor C is used to hold the signal voltage written into the pixel P. When the refresh operation is finished, the scan line G transmits a non-select signal to the pixel P, so that the transistor T is not conducted and the liquid crystal layer LC is maintained at a predetermined state by the electric charges stored by the capacitor C. The above operation is a driving process of a pixel.

Following, a conventional driving method and a driving method in accordance with an embodiment of the present disclosure are respectively used to drive a pixel array. Each pixel of the pixel array includes a transistor and a capacitor as shown in FIG. 1.

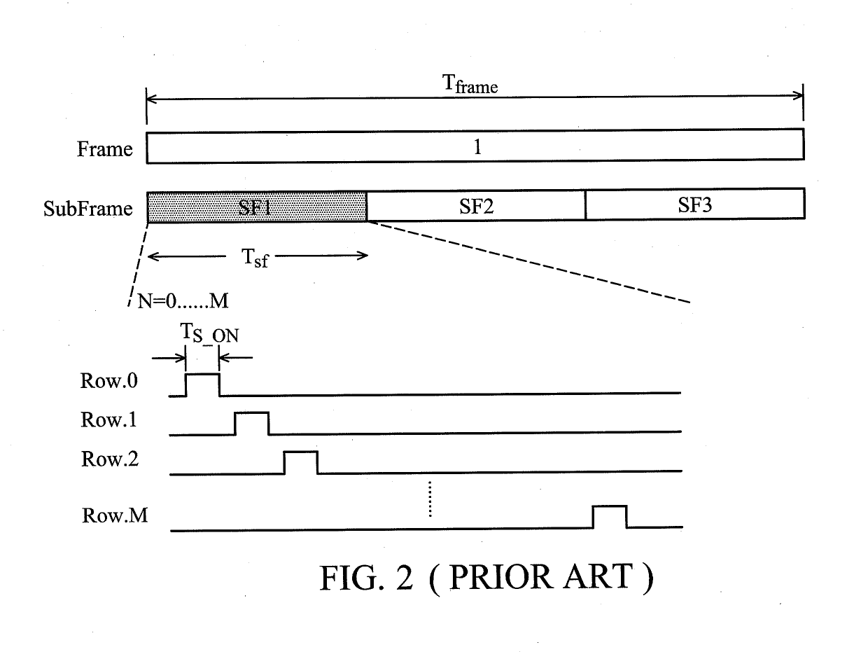

FIG. 2 is a diagram showing a conventional driving method of an active matrix type bistable chiral nematic liquid crystal display. In FIG. 2, a driving scheme within a frame period T_{frame} is shown. With respect to a common liquid crystal display which adjusts voltage to display gray level, the active matrix type bistable chiral nematic liquid crystal display usually drives pixels in multiple subframes N (N=0, 1, . . . , M), which are divided from a frame, to display gray level. From FIG. 2, it is understood that a frame is divided into 3 subframes SF1˜SF3 (namely, N=3), and the driving period of each subframe is T_{sf}. In a driving operation of a subframe, totally M+1 pixel rows Row.0˜Row.M are selected in sequence, and the selected period of each pixel row is T_{S}_{_{—}}_{ON}.

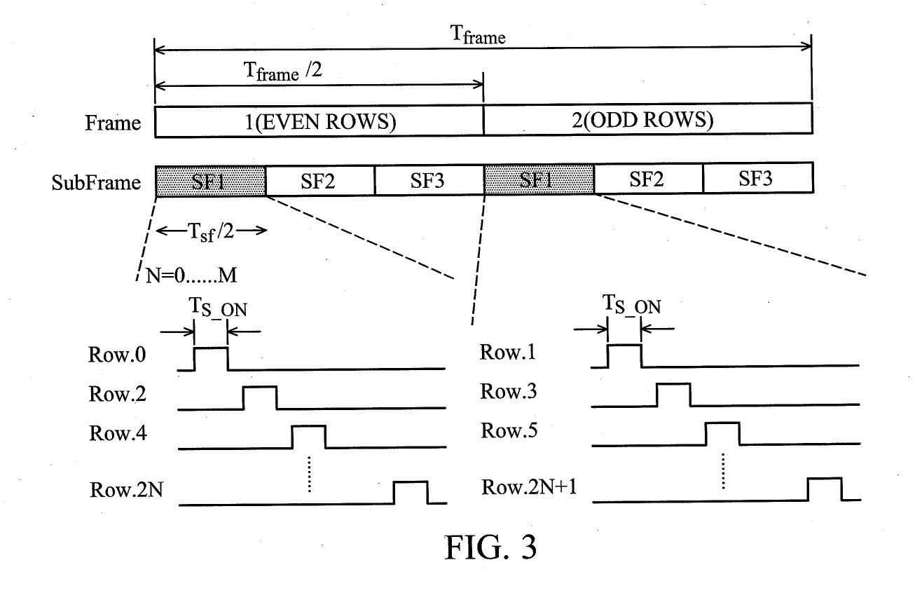

FIG. 3 is a diagram showing a driving method of an active matrix type bistable chiral nematic liquid crystal display in accordance with an embodiment of the present disclosure. In the driving method of the embodiment, a frame is divided into 2 fields to be driven respectively. In the example of FIG. 3, the field formed by even pixel rows (even-row field is called hereafter for brief) is driven first and then the field formed by odd pixel rows (odd-row field is called hereafter for brief) is driven. When the even-row field is driven, the pixel rows Row.0, Row.2, Row.4, . . . , Row.2N are driven in sequence. Because the pixel rows to be driven correspond to a half of a full frame, each subframe needs a driving period which is half as long as the driving period for a conventional subframe (namely, T_{sf}/2). Similarly, when the odd-row field is driven, the pixel rows Row.1, Row.3, Row.5, . . . , Row.2N+1 are driven in sequence. Because the pixel rows to be driven correspond to a half of a full frame, each subframe needs a driving period which is half as long as the driving period for a conventional subframe (namely, T_{sf}/2). Note that the selected period of each pixel row is still T_{S}_{_{—}}_{ON}.

The above embodiment uses an interlace scan to drive the active matrix type bistable chiral nematic liquid crystal display. In a frame period T_{frame}, even pixel rows and odd pixel rows are driven in sequence. After even pixel rows are driven, a picture is sensed y human eyes. Namely, after a period T_{frame}/2, human eyes sense a picture. Therefore, with respect to the conventional driving method wherein a picture is provided to human eyes after a frame period T_{frame}, the disclosure doubles frame rate so that dynamic images can be displayed more smoothly and meanwhile power consumption can be lowered.

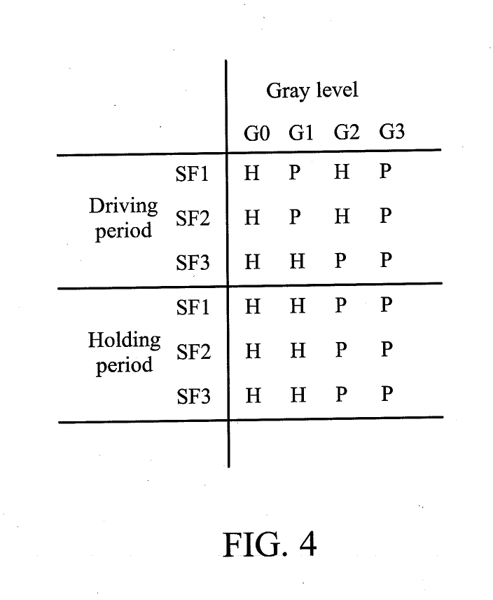

FIG. 4 is a diagram showing the displayable gray levels of an active matrix type bistable chiral nematic liquid crystal display when the driving method shown in FIG. 3 is utilized. According to the gray level driving method of the present disclosure, the bistable chiral nematic liquid crystal is driven to a bright state or a dark state in a subframe, and a desired gray level is determined by the total number of bright/dark states of several subframes.

The bistable chiral nematic liquid crystal has three states: a planar state (P state is called later for brief), a focal-conic state (F state is called later for brief), and a homeotropic state (H state is called later for brief). The P state and the F state are two stable state of the bistable chiral nematic liquid crystal, and the H state is a transient state. The conventional art takes the P state as a bright state and the F state as a black state. However, the H state can obtain higher transmittance than the F state in the display, so in the active matrix type bistable chiral nematic liquid crystal display of the present disclosure, the P state is taken as a bright state and the H state is taken as a dark state. According to the driving method shown in FIG. 3, in the image refresh process within a frame period T_{frame}, while the even-row field is being driven (namely, the field formed by even pixel rows is within a driving period), the odd-row field is not selected (namely, the field formed by odd pixel rows is within a holding period). Similarly, while the odd-row field is being driven (namely, the field formed by odd pixel rows is within a driving period), the even-row field is not selected (namely, the field formed by even pixel rows is within a holding period). Therefore, the present disclosure design a gray level driving method as shown in FIG. 4 based on the characteristic that each pixel must pass a driving period and a holding period in a frame.

As shown in FIG. 4, the active matrix type bistable chiral nematic liquid crystal display of the present disclosure can display 4 gray levels G0˜G3. For the 4 gray levels G0˜G3, H-H-H, P-P-H, H-H-P, and P-P-P states are respectively shown in 3 successive subframes of the driving period. According to the embodiment, the lowest gray level is displayed by driving a liquid crystal to an H state in every subframe, and the highest gray level is displayed by driving a liquid crystal to a P state in every subframe. As the gray level increases by 1 the number of the P states increases by 2. The state of the liquid crystal within the holding period must be the state after the last driving of the driving period. For this reason, the state which the liquid crystal is driven to in the last suframe of the driving period (the subframe SF3 of the driving period in this embodiment) should be determined appropriately. According to the embodiment, for the first half of all gray levels (namely, gray levels G0 and G1), a liquid crystal must be driven to the H state in the last suframe of the driving period, and for the second half of all gray levels (namely, gray levels G2 and G3), a liquid crystal must be driven to the P state in the last suframe of the driving period.

In the interlace scan driving method of the present disclosure, the combination of the H state and the P state is utilized to realize gray levels and raise contrast ratio of images.

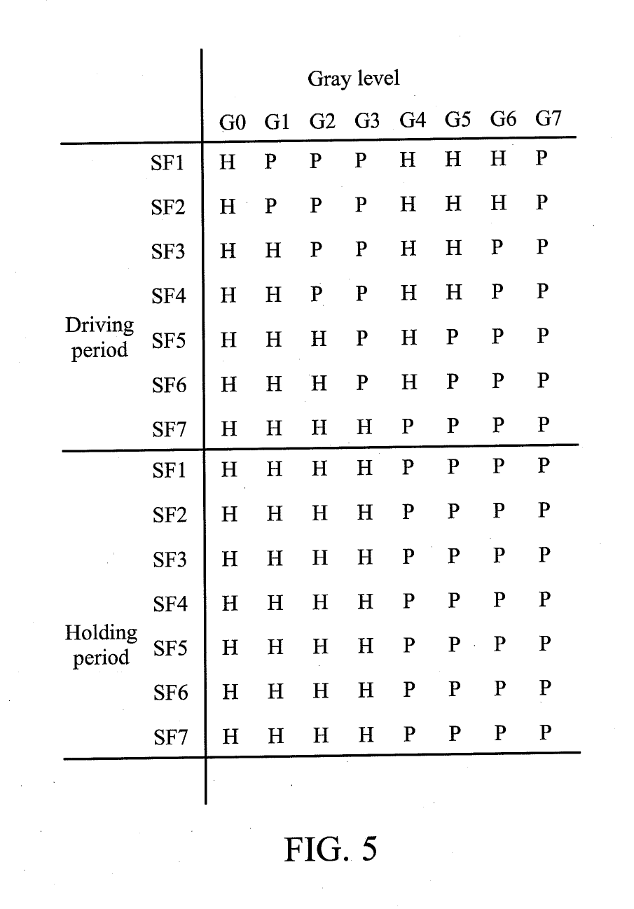

FIG. 5 is a diagram showing the displayable gray levels of an active matrix type bistable chiral nematic liquid crystal display in accordance with another embodiment of the present disclosure. In addition to the above embodiment where the active matrix type bistable chiral nematic liquid crystal display is driven with 3 subframes to display 4 gray levels, the driving method of the active matrix type bistable chiral nematic liquid crystal display of this embodiment, as shown in FIG. 5, is using 7 subframes for driving to display 8 gray levels G0˜G7. Therefore, the relation between the number of subframes and the number of the displayable gray levels is that when the number of the subframes is N (namely, a field is driven N times) the number of displayable gray level is N+1. The features of this embodiment are similar to the embodiment of FIG. 4. The lowest gray level is displayed by driving a liquid crystal to an H state in every subframe, and the highest gray level is displayed by driving a liquid crystal to a P state in every subframe. As the gray level increases by 1 the number of the P states increases by 2. For the first half of all gray levels (namely, gray levels G0, G1, G2, and G3), a liquid crystal must be driven to the H state in the last suframe of the driving period, and for the second half of all gray levels (namely, gray levels G4, G5, G6, and G7), a liquid crystal must be driven to the P state in the last suframe of the driving period.

According to the gray level driving method of the present disclosure, the number of gray levels is raised so that the image data bandwidth can be increased..

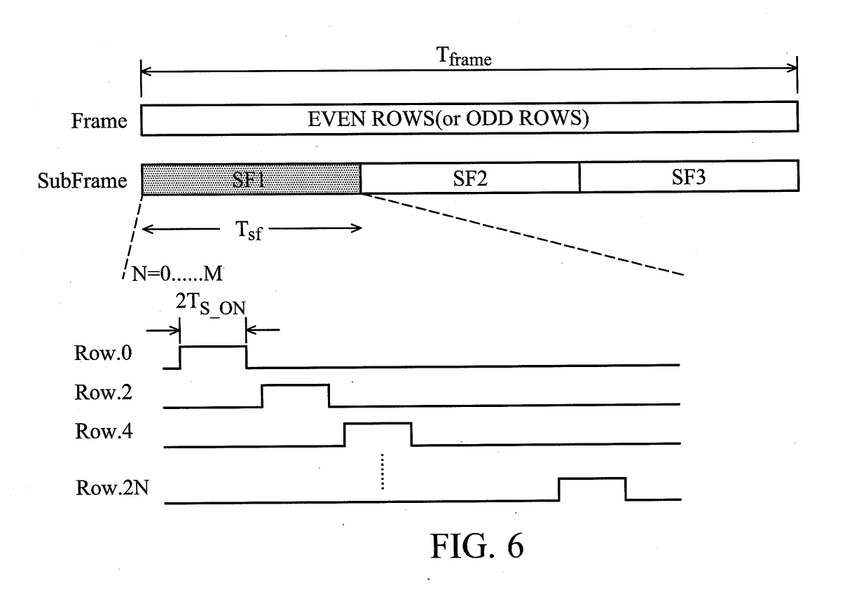

FIG. 6 is a diagram showing a driving method of an active matrix type bistable chiral nematic liquid crystal display in accordance with another embodiment of the present disclosure. If the interlace scan driving method of the present disclosure is used to drive only one of the even-row field and the odd-row field in a frame period T_{frame} and drive the other in the next frame period T_{frame}, the period of each pixel row being selected in a subframe will be twice as long as the original period (namely, the selected period becomes 2T_{S}_{—}_{ON}). For the H state which needs to reach a high voltage charge/discharge, increasing the driving period of each pixel row can display gray levels more precisely and relieve the flicker issue.

While the disclosure has been described by way of example and in terms of the preferred embodiments, it is to be understood that the disclosure is not limited to the disclosed embodiments. For example, the disclosure is not limited to dividing a frame into an even-row field and an odd-row field. The disclosure can divide a frame into 3 fields, for example, a first field formed by the first, fourth, seventh, . . . , and (3N+1)-th pixel rows, a second field formed by the second, fifth, eighth, . . . , and (3N+2)-th pixel row, and a third field formed by the third, sixth, ninth, . . . , and 3N-th pixel row.

Moreover, the driving method of the present disclosure is applied to a pixel array, wherein each pixel has a transistor and a capacitor. However, as long as applied in an active type liquid crystal display, the driving method of the present disclosure can also be applied to a pixel array, wherein each pixel has the other number of transistors and capacitors.

The driving method of the present disclosure where the H state and the P state are combined to display gray levels is not limited to displaying 4 or 8 gray levels. As long as the driving period for each pixel row is not too short, the number of subframes can be changed appropriately to determine the number of gray levels.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A driving method for an active matrix type bistable chiral nematic liquid crystal display, comprising:
dividing a frame into at least two fields, wherein each field is formed by a plurality of pixel rows;
driving one of the at least two fields by a plurality of driving operations, wherein a liquid crystal unit of each pixel in the field is driven to one of two predetermined states in each driving operation; and
driving the other fields by the plurality of driving operations.

2. The driving method for the active matrix type bistable chiral nematic liquid crystal display as claimed in claim 1, wherein the at least two fields comprise a field formed by even pixel rows and a field formed by odd pixel rows.

3. The driving method for the active matrix type bistable chiral nematic liquid crystal display as claimed in claim 1, wherein the number of the plurality of driving operations is N, and the number of displayable gray levels of the active matrix type bistable chiral nematic liquid crystal display is N+1.

4. The driving method for the active matrix type bistable chiral nematic liquid crystal display as claimed in claim 1, wherein the two predetermined states are a P state (planar state) and a H state (homeotropic state).

5. The driving method for the active matrix type bistable chiral nematic liquid crystal display as claimed in claim 4, wherein when one of the at least two fields is being driven, the liquid crystal unit of each pixel in the other fields is maintained at the P or H state which is determined by the last driving operation during the period of the other fields were driven.

6. The driving method for the active matrix type bistable chiral nematic liquid crystal display as claimed in claim 5, wherein the gray level of each pixel is determined by the combination of the number of the P states or the H states within a driving period and the number of the P states or the H states within a non-driving period.

7. The driving method for the active matrix type bistable chiral nematic liquid crystal display as claimed in claim 6, wherein the lowest gray level is defined by the combination of all H states, and the highest gray level is defined by the combination of all P states, wherein as the gray level increases by 1 the number of the P states increases by 2.

8. The driving method for the active matrix type bistable chiral nematic liquid crystal display as claimed in claim 6, wherein when a pixel is to display one of the gray levels which are belong to the lower half of all displayable gray levels, the liquid crystal unit of the pixel is driven to the H state in the last driving operation when the field which the pixel belongs to is being driven, and when a pixel is to display one of the gray levels which belong to the higher half of all displayable gray levels, the liquid crystal unit of the pixel is driven to the P state in the last driving operation when the field which the pixel belongs to is being driven.

9. The driving method for the active matrix type bistable chiral nematic liquid crystal display as claimed in claim 1, wherein the driving method is applied to a pixel array, and each pixel of the pixel array has a transistor and a capacitor.

10. An active matrix type bistable chiral nematic liquid crystal display, comprising:
a pixel array formed by a plurality of pixel rows and pixel columns,
wherein the active matrix type bistable chiral nematic liquid crystal display is driven with the driving method for the active matrix type bistable chiral nematic liquid crystal display as claimed in claim 1.
